(19) United States
(12) Patent Application Publication
(10) Pub. No.: US 2026/0124723 A1
(43) Pub. Date: May 7, 2026

(54) DIGITAL TORQUE WRENCH

(71) Applicant: Calvin V Levine JR., Parkville, MD (US)

(72) Inventor: Calvin V Levine JR., Parkville, MD (US)

(21) Appl. No.: 19/439,968

(22) Filed: Jan. 5, 2026

Related U.S. Application Data
(60) Provisional application No. 63/715,899, filed on Nov. 4, 2024.

(51) Int. Cl. B25B 23/142; B25B 13/04; B25B 13/46

(52) U.S. Cl. CPC B25B 23/1425; B25B 13/04; B25B 13/46

(57) ABSTRACT

A digital torque wrench is disclosed. The digital torque wrench includes an elongated shaft having a proximal end and a distal end, each end including a head profile configured to engage a fastener. A torque sensing element is disposed within the digital torque wrench and is configured to generate a signal corresponding to applied torque. An electronic control unit receives the signal and determines a torque value. One or more user input members are operably coupled to the electronic control unit and are configured to allow a user to set a preset torque value. The electronic control unit compares the determined torque value with the preset torque value. One or more indicators provide an output when the applied torque meets a condition relative to the preset torque value. A display is configured to display torque information. A power source provides electrical power to the digital torque wrench.

### CROSS REFERENCE TO RELATED APPLICATIONS

This application claims priority from a U.S. Provisional Patent Appl. No. 63/715,899, filed on Nov. 4, 2024, which is incorporated herein by reference in its entirety.

### FIELD OF INVENTION

The present invention relates generally to hand tools, and more particularly to a digital torque wrench configured to measure, detect, and display an applied torque value during tightening or loosening of a fastener.

### BACKGROUND

Torque wrenches are commonly used hand tools in industrial, automotive, mechanical, and workshop environments for tightening and loosening nuts and bolts. Such wrenches are manufactured in various lengths, sizes, and drive configurations to accommodate different fastener dimensions and torque requirements.

In many conventional applications, users rely on personal judgment, experience, or tactile feedback to estimate the amount of torque applied to a fastener. This subjective approach often leads to inaccurate torque application. Under-tightening may result in loose fasteners, vibration, or component failure, while over-tightening may cause thread stripping, deformation, seal damage, or structural failure of the associated components.

These issues are further exacerbated when fasteners are located in confined or hard-to-reach spaces, where limited visibility, restricted hand movement, and awkward working angles make it difficult for the user to accurately apply or assess the required torque using standard mechanical wrenches.

Accordingly, there exists a need for improved wrench systems that enable accurate measurement and indication of applied torque, thereby assisting users in applying a correct and controlled amount of torque to fasteners, reducing the risk of damage, improper assembly, and safety hazards.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

A principal object of the present invention is to provide a digital torque wrench configured to indicate whether a correct or predefined amount of torque is being applied to a fastener.

Another object of the present invention is to provide a digital torque wrench that enables a user to set a desired torque value easily and quickly.

Another object of the present invention is to provide a digital torque wrench having a display that allows the user to clearly and conveniently view the applied torque value in real time.

Another object of the present invention is to provide a digital torque wrench having a form factor that closely resembles that of a conventional or standard wrench, thereby minimizing user retraining.

Another object of the present invention is to provide a digital torque wrench that is simple in construction and economical to manufacture.

The present invention generally relates to a digital torque wrench configured to apply a predetermined amount of torque to a fastener. In accordance with one aspect of the invention, the digital torque wrench includes an elongated shaft having a proximal end and a distal end, each end including a head profile configured to engage a nut or bolt. A torque sensing element is disposed within the digital torque wrench and is configured to detect an applied torque and generate a corresponding signal.

In accordance with another aspect of the invention, an electronic control unit is operably coupled to the torque sensing element and is configured to determine a torque value based on the generated signal. One or more user input members are provided to allow a user to set a preset torque value. The electronic control unit compares the applied torque value with the preset torque value during operation.

In accordance with a further aspect of the invention, one or more indicators are operably coupled to the electronic control unit and configured to provide feedback to the user when the applied torque approaches, reaches, or exceeds the preset torque value. The indicators may include visual indicators, audible indicators, light indicators, tactile haptic indicators, or combinations thereof. A display may be provided to present torque-related information to the user.

In accordance with yet another aspect of the invention, the torque sensing element, electronic control unit, power source, and user input members are housed within the shaft to provide a compact form factor that resembles a conventional wrench. The digital torque wrench may include a replaceable battery power source and is suitable for use in confined or hard-to-reach environments across a variety of applications.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a top and side perspective view of a digital torque wrench, according to an exemplary embodiment of the present invention.

FIG. 2 illustrates a bottom and side perspective view of the digital torque wrench, according to an exemplary embodiment of the present invention.

FIG. 3 illustrates an enlarged view of a front side of a middle portion of the digital torque wrench, according to an exemplary embodiment of the present invention.

FIG. 4 illustrates an enlarged view of a bottom side of the middle portion of the digital torque wrench, according to an exemplary embodiment of the present invention

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention pertains to a digital torque wrench configured to apply a preset or predefined amount of torque while fastening or loosening nuts and bolts. The digital torque wrench generally resembles a conventional wrench and includes an elongated body having a proximal end and a distal end. Each of the proximal end and the distal end includes a head portion having a profile configured to engage and rotate a corresponding nut or bolt. The digital torque wrench may be manufactured in various lengths and configurations, and the head portions may be provided in different sizes and profiles. For example, the head profiles may be manufactured in standard sizes commonly known in the art, such as 9 mm, 10 mm, 12 mm, and the like, without departing from the scope of the present invention.

The disclosed digital torque wrench is a handheld tool configured to apply a predetermined amount of torque to nuts and bolts, including in confined or hard-to-reach spaces. In certain embodiments, the digital torque wrench includes a ratcheting mechanism that facilitates engagement with fasteners in locations where conventional wrenches may be difficult to operate. The digital torque wrench further includes a digital display for indicating an applied torque value and one or more indicators configured to signal when a preset torque level has been reached. Such indicators may include visual indicators, audible alerts, or a combination thereof. In some implementations, the digital torque wrench includes one or more input controls configured to allow a user to set a desired torque value. The digital torque wrench may be powered by a battery and is portable for use across a variety of applications, including automotive, aerospace, industrial, and manufacturing environments.

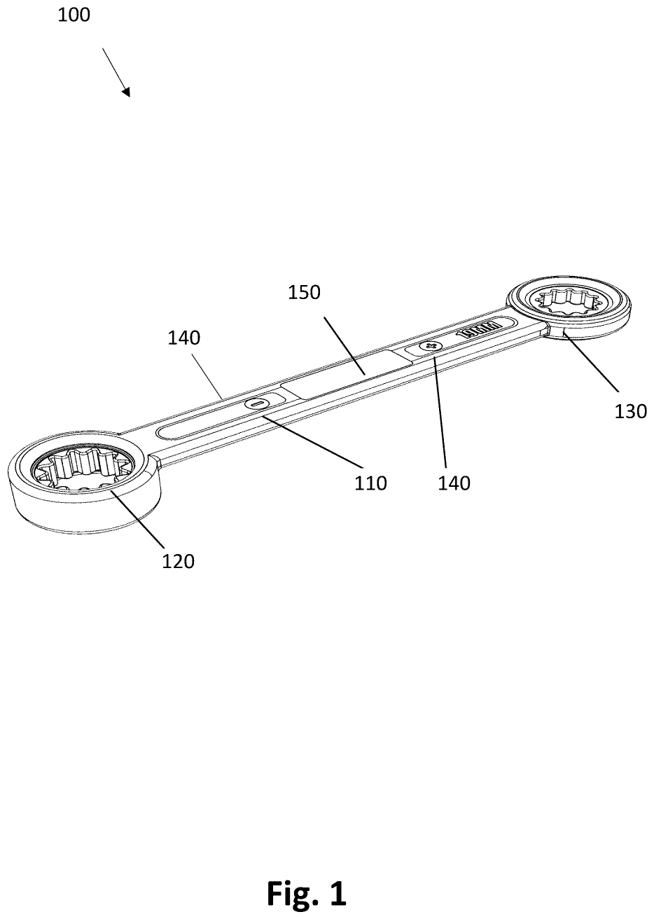

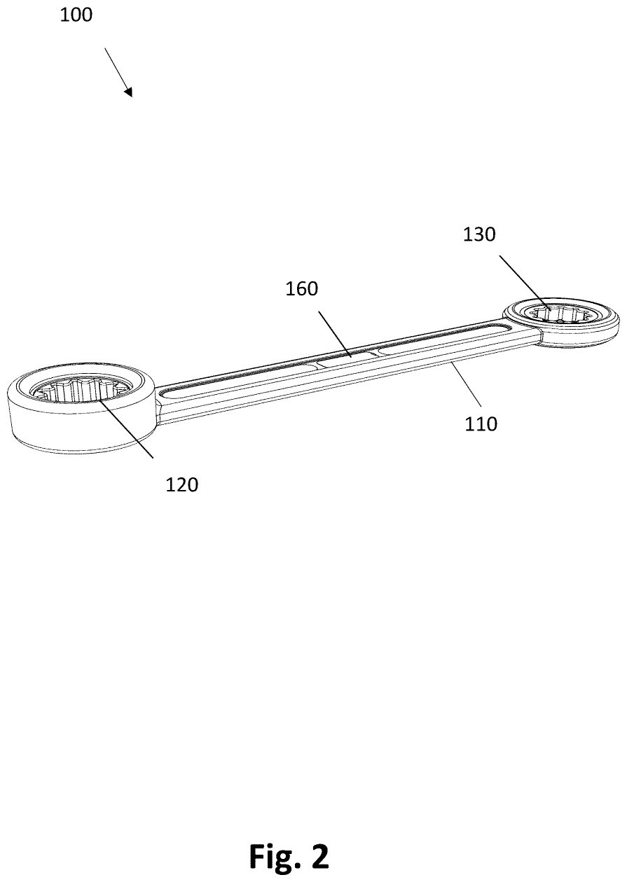

Referring to FIGS. 1 and 2, the digital torque wrench 100 includes an elongated shaft 110 having a proximal end and a distal end. A proximal head profile 120 is disposed at the proximal end of the shaft 110, and a distal head profile 130 is disposed at the distal end of the shaft 110. Each of the proximal head profile 120 and the distal head profile 130 includes engagement features, such as teeth or facets, configured to engage a nut or a bolt head. The proximal head profile 120 and the distal head profile 130 may be of the same size or of different sizes, and variations in shape, size, and configuration of the head profiles are within the scope of the present invention.

In certain embodiments, electronic components of the digital torque wrench 100, including a torque sensing element, an electronic control unit, a power source, and one or more user input members, are housed within the shaft 110. The shaft 110 may include an internal cavity configured to receive and protect the electronic components from environmental exposure, mechanical impact, and contaminants. The power source may comprise one or more batteries disposed within the shaft 110 and electrically coupled to the electronic control unit and the torque sensing element.

The one or more user input members 140, such as buttons or switches, may be mounted on or extend through an outer surface of the shaft 110 while being operably coupled to the electronic control unit. In such embodiments, the shaft 110 may include sealed openings, flexible membranes, or protective covers that allow user interaction with the input members while maintaining structural integrity and environmental protection. Enclosing the electronic components within the shaft 110 contributes to a compact form factor and allows the digital torque wrench 100 to closely resemble the appearance and handling of a conventional wrench.

In various embodiments, the torque sensing element comprises one or more strain gauges, load cells, piezoelectric sensors, magnetic sensors, optical sensors, or combinations thereof, disposed along the shaft 110 or within one of the head profiles. The torque sensing element is configured to generate a signal corresponding to torsional deformation or force experienced by the digital torque wrench 100 as torque is applied to a fastener.

The signal generated by the torque sensing element is transmitted to the electronic control unit, which is configured to convert the signal into a torque value using one or more calibration parameters stored in memory. The electronic control unit may further compensate for temperature variations, material properties, or manufacturing tolerances to improve measurement accuracy. The calculated torque value is used for display, comparison with a preset torque value, and generation of one or more user indicators.

The digital torque wrench 100 further includes a torque setting assembly configured to allow a user to select and set a desired torque value. In one embodiment, the torque setting assembly includes one or more user input members disposed on a middle portion of the shaft 110 and operably coupled to the electronic control unit. The electronic control unit stores the selected torque value as a preset torque threshold.

During operation, the electronic control unit compares the detected torque value received from the torque sensing element with the preset torque value. When the applied torque approaches, reaches, or exceeds the preset torque value, the electronic control unit actuates one or more indicators to provide feedback to the user.

The one or more indicators may include a visual indicator, such as a digital display configured to show numerical torque values, one or more light indicators configured to change state, and/or an audible indicator configured to emit a sound. The indicators may operate individually or in combination to alert the user and assist in accurately applying the desired torque while preventing under-tightening or over-tightening.

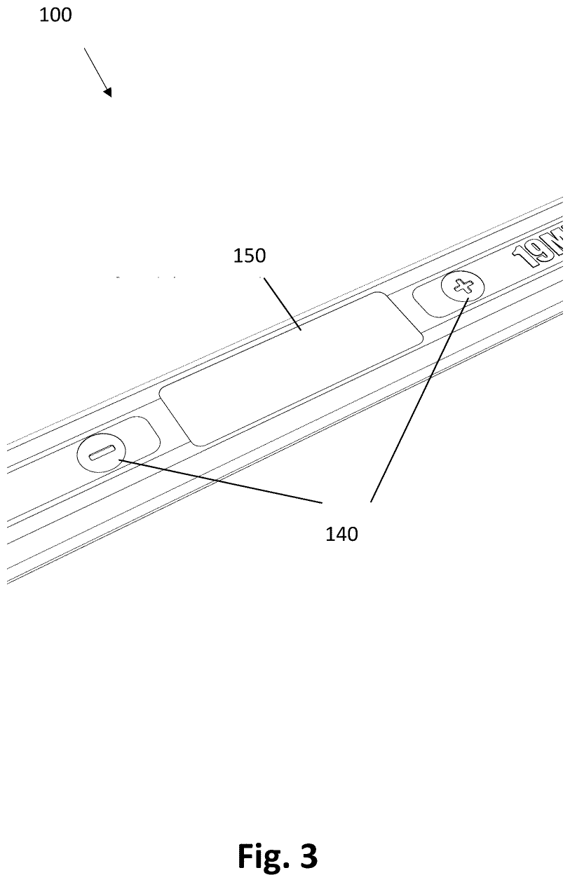

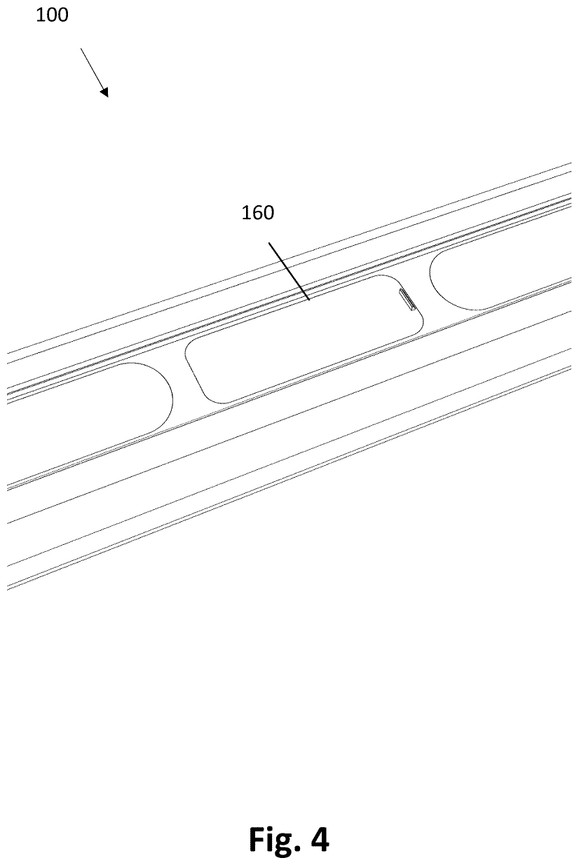

Referring again to FIG. 1-4, the digital torque wrench 100 may further include a display 150 disposed on an exterior surface of the shaft 110 and operably coupled to the electronic control unit. The display 150 may be configured to display one or more of an applied torque value, a preset torque value, warning indicators, or battery status information. Referring to FIG. 2, the digital torque wrench 100 further includes a battery compartment 160 configured to house one or more replaceable batteries that provide power to the electronic components.

In certain embodiments, the one or more indicators further include a tactile or haptic feedback element configured to provide a physical feedback signal to the user when the applied torque approaches, reaches, or exceeds the preset torque value. The haptic feedback element may comprise a vibration generator, motor, piezoelectric actuator, or similar tactile feedback device disposed within the shaft 110 and operably coupled to the electronic control unit. The tactile feedback enables the user to perceive torque feedback through touch, including in low-visibility or high-noise environments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A digital torque wrench, comprising:
an elongated shaft having a proximal end and a distal end;
a head profile disposed at the proximal end of the shaft, the head profile configured to engage a fastener;
a torque sensing element disposed within the digital torque wrench and configured to generate a signal corresponding to an applied torque;
an electronic control unit operably coupled to the torque sensing element and configured to determine a torque value based on the signal;
one or more user input members operably coupled to the electronic control unit and configured to allow a user to set a preset torque value;
one or more indicators operably coupled to the electronic control unit and configured to provide an output when the applied torque satisfies a condition relative to the preset torque value; and
a power source electrically coupled to the electronic control unit.

2. The digital torque wrench of claim 1, wherein the one or more indicators comprise at least one of a visual indicator, an audible indicator, or a light indicator.

3. The digital torque wrench of claim 1, further comprising a display configured to display at least one of the applied torque value or the preset torque value.

4. The digital torque wrench of claim 1, wherein the electronic control unit is configured to compare the applied torque value with the preset torque value and actuate the one or more indicators when the applied torque approaches, reaches, or exceeds the preset torque value.

5. The digital torque wrench of claim 1, wherein the one or more user input members comprise buttons or switches disposed on an exterior surface of the shaft.

6. The digital torque wrench of claim 1, wherein the power source comprises one or more replaceable batteries.

7. The digital torque wrench of claim 1, wherein the shaft has a form factor corresponding to a conventional wrench

8. A method of applying torque to a fastener using a digital torque wrench, the method comprising:
providing a digital torque wrench having an elongated shaft, a torque sensing element, an electronic control unit, one or more user input members, and one or more indicators;
receiving, via the one or more user input members, a user-selected preset torque value;
detecting an applied torque using the torque sensing element while the digital torque wrench engages the fastener;
generating a signal corresponding to the applied torque;
determining, by the electronic control unit, a torque value based on the signal;
comparing the torque value with the preset torque value; and
activating the one or more indicators when the applied torque satisfies a condition relative to the preset torque value.

9. The method of claim 8, wherein activating the one or more indicators comprises activating at least one of a visual indicator, an audible indicator, or a light indicator.

10. The method of claim 8, further comprising displaying at least one of the applied torque value or the preset torque value on a display of the digital torque wrench.

11. The method of claim 8, wherein activating the one or more indicators occurs when the applied torque approaches, reaches, or exceeds the preset torque value.
